(19) United States
(12) Patent Application Publication
(10) Pub. No.: US 2011/0031753 A1
(43) Pub. Date: Feb. 10, 2011

(54) APPARATUS, SYSTEM, AND METHOD FOR IMPROVED WATER BASED POWER GENERATION

(75) Inventors: Doug Moore, Riesel, TX (US); Allen James Williston, Foristell, MO (US)

Correspondence Address: The Caldwell Firm, LLC, P.O. Box 59655, Dallas, TX, 75229, US

(73) Assignee: Abundant Energy, LLC, Plano, TX (US)

(21) Appl. No.: 12/534,854

(22) Filed: Aug. 4, 2009

(51) Int. Cl. F03B 13/08; F03B 13/00

(52) U.S. Cl. 290/54; 290/52

(57) ABSTRACT

The disclosed embodiments include a power generating system and method. The system includes a barge comprising a working platform and water support members. The barge provides an operating surface on a body of water, and the water support members define a water channel in the body of water. The system also includes an axle coupled to the barge and a turbine coupled to the axle such that the turbine can be lifted into and out of the water channel. The system configures the turbine to rotate on an axis of the axle in the water channel. Finally, the system includes a gearbox configured to transmit rotational energy of the axle to a generator to produce electricity and a lift coupled to the axle. The system configures the lift to variably raise and lower the turbine.

### TECHNICAL FIELD

The present invention relates generally to the field of electricity generation and, more particularly, to a system and method for improved water-based power generation.

### BACKGROUND OF THE INVENTION

Electricity forms the backbone of modern society. Without electricity, much of the technology that brings order to the world would not function. As first-world nations continue to advance, and third-world nations industrialize and move into first-world status, the world faces increasing demands for electricity. Presently, commercial electrical generation primarily relies on electromagnetic induction, in which mechanical energy operates an electromagnetic induction generator to produce electricity. Generally, a power generation plant based on electromagnetic induction produces steam, and the steam causes a turbine to operate or spin. As the turbine spins, it produces power by operating an electromagnetic induction generator mechanically coupled to the turbine.

Production of steam requires a significant amount of energy. One method of steam production uses nuclear fission. In nuclear fission, a nuclear reaction occurs generating a large amount of heat. The nuclear power plant uses the heat generated by the nuclear reaction to boil water and produce steam. As described above, the nuclear power plant uses the produced steam to generate power. Unfortunately, nuclear power plants require significant capital to construct and operate. In many cases, the capital requirements limit use of nuclear power plants to those countries in which the government can subsidize the construction and operation of the plant, or to those countries where the individual consumer's wealth allows the consumer to afford an increased cost for the resultant electricity. In addition, the radiation produced by the nuclear reaction is extremely toxic, and the spent nuclear fuel remains radioactive for a significant period of time, which requires costly containment facilities for the spent fuel.

Another more common method of steam production for electrical power generation burns fossil fuels, such as coal, natural gas, and petroleum, to boil water and produce steam. This method of production avoids the risks of radioactive toxicity associated with nuclear power. Fossil fuels burn into a particulate matter that dissipates through the air, eliminating the need for expensive containment facilities associated with the radioactive fuel of nuclear reactors. Unfortunately, the particulate matter resulting from the combustion of fossil fuels contributes significantly to air pollution, which can cause problems of its own, including serious health problems for many individuals. When compared to nuclear power generation, startup costs to use fossil fuels to generate electricity are typically smaller. However, fossil fuels are a finite resource. As world demand for fossil fuels for electrical power generation and other uses increases, the world faces increased costs for fossil fuels, especially as fossil fuels begun to become scarce, potentially making fossil fuels cost prohibitive.

To combat problems with fossil fuels, some electrical power generation uses water and/or wind instead of steam to spin a turbine. Wind generation relies on naturally occurring wind or solar updraft towers that create wind artificially by using sunlight to heat air within a chimney. In both cases, power generation depends on the occurrence of a natural phenomenon. In the case of wind turbines, the turbine size necessary to generate appreciable electrical energy dictates fixation of the wind turbines to a specific location. Because the wind turbines are fixed, in the event that the wind ceases, the wind turbine ceases to generate electricity. Thus, wind turbines need an almost constant flow of wind; this limitation severely restricts suitable locations for wind turbine installation. In the case of a solar updraft tower, sunlight requirements limit installation to those areas that continually receive sunlight.

Another attempt to combat the problems of fossil fuels and wind generation involves use of hydroelectric power. Hydroelectric power uses running water in place of steam to operate a turbine. Generally, hydroelectric power requires damming of a river or some other body of water. The dam traps water behind the dam to build pressure, channeling water across turbines. In addition, the dam ensures a constant flow of water at the power generation station. Much like nuclear energy, hydroelectric power requires a significant capital investment that often only governments can bear. Governments without access to the necessary capital to build a dam cannot use hydroelectric power. In addition, damming a river or other body of water significantly decreases the value of the flooded land and infringes on private property rights of the citizens who own the flooded land. The necessity of a dam also places geographic limitations on the use of hydroelectric power. Hydroelectric dams require specific geographic elements for successful construction and operation. Consequently, a finite number of locations exist for suitable hydroelectric dam construction. Other hydroelectric methods, such as use of tidal power face similar problems in that the generation method requires a significant capital contribution and specific geographic limitations that make these methods unsuitable for developing countries.

Therefore, there is a need for an improved power generation method that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A first embodiment provides a power generating system comprising a barge comprising a working platform, a left water support member, and a right water support member. The system configures the barge to provide an operating surface on a body of water, wherein the left water support member and the right water support member define a first water channel. As disclosed, the first water channel comprises a portion of the body of water to a depth within the body of water, wherein a water flow from the body of water directionally flows through the first water channel. The system also provides a first axle, the first axle coupled to the barge, and a first turbine comprising blades, the first turbine coupled to the first axle such that the first turbine disposes into and out of the first water channel. In addition, the system configures the first turbine to rotate on an axis of the first axle in the first water channel according to the water flow, and a first gearbox configured to transmit rotational energy of the first axle to a first generator, the rotational energy operating the first generator to produce electricity. Finally, the system comprises a first lift coupled to the first axle, the first lift configured to variably raise and lower the first turbine.

Another embodiment discloses a power generating system comprising a barge comprising a working platform, a left water support member, and a right water support member. The system configures the barge to provide an operating surface on a body of water. In addition, the system further comprises the first water support member comprising a first vertical wall, and the second water support member comprising a second vertical wall, wherein the left water support member and the right water support member define a first water channel. As disclosed, the first water channel comprises a portion of the body of water to a depth within the body of water, wherein a water flow from the body of water directionally flows through the first water channel. The system also comprises eight axles, a left-series comprising four axles in series, and a right-series comprising four axles in series, the eight axles coupled to the barge. The system further comprises eight turbines, the eight turbines comprising a left-series comprising four turbines in series each left-series turbine coupled to a respective left-series axle such that the left-series turbines dispose into and out of the first water channel. The eight turbines further comprise a right-series comprising four turbines each right-series turbine coupled to a respective right-series axle such that the right-series turbines dispose into and out of the first water channel, wherein the eight turbines further comprise blades. The system configures the eight turbines to rotate on an axis of the respective eight axles in the first water channel according to the water flow, and eight gearboxes configured to transmit rotational energy of the eight axles to eight generators, the rotational energy operating the eight generators to produce electricity. Finally, the system comprises eight lifts coupled to the eight axles, the eight lifts configured to variably raise and lower the eight turbines.

Yet another embodiment discloses a method for generating electricity comprising placing an energy barge in a body of water, the energy barge comprising a first turbine, and the energy barge receiving an electrical load. The method continues by lowering the first turbine into the body of water such that a water flow in the body of water rotates the first turbine to drive a generator to produce electricity to meet the electrical load.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 provides a perspective representation illustrating exemplary elements in accordance with one embodiment;

FIG. 2 provides a schematic representation of FIG. 1 along line 2-2 illustrating in accordance with one embodiment;

FIG. 3 provides an additional schematic representation of FIG. 1 along line 2-2 in accordance with one embodiment;

FIGS. 4-9 provide schematic representations of FIG. 1 along line 4-4 of additional elements in accordance with various embodiments of the present invention; and

FIGS. 10-13 provide schematic representations in accordance with one embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

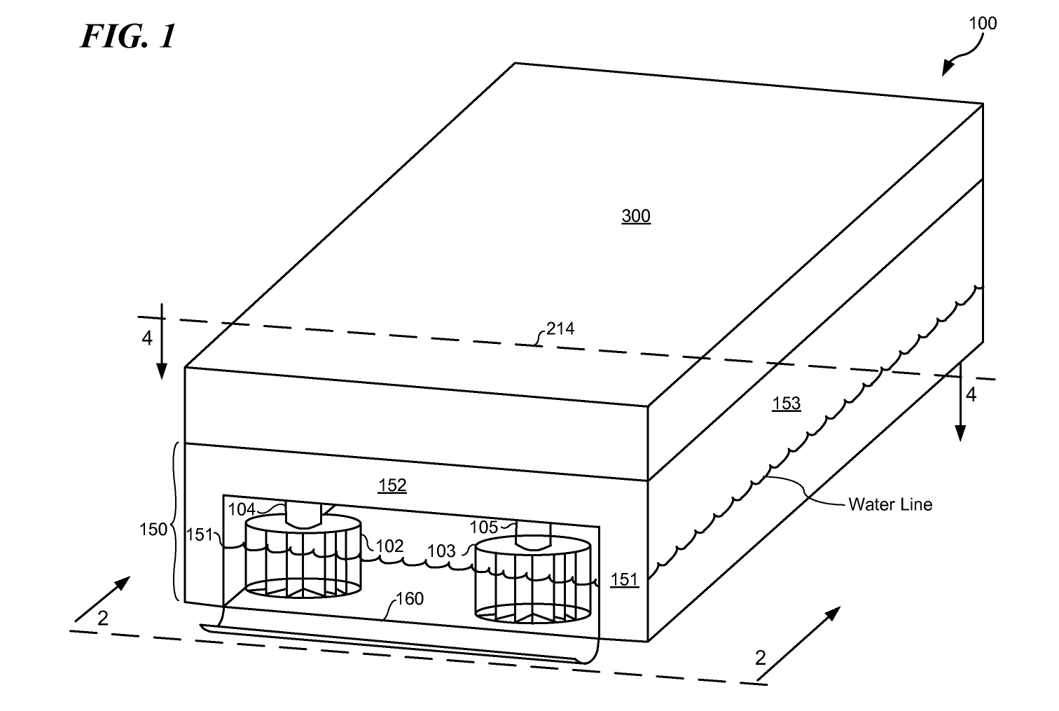

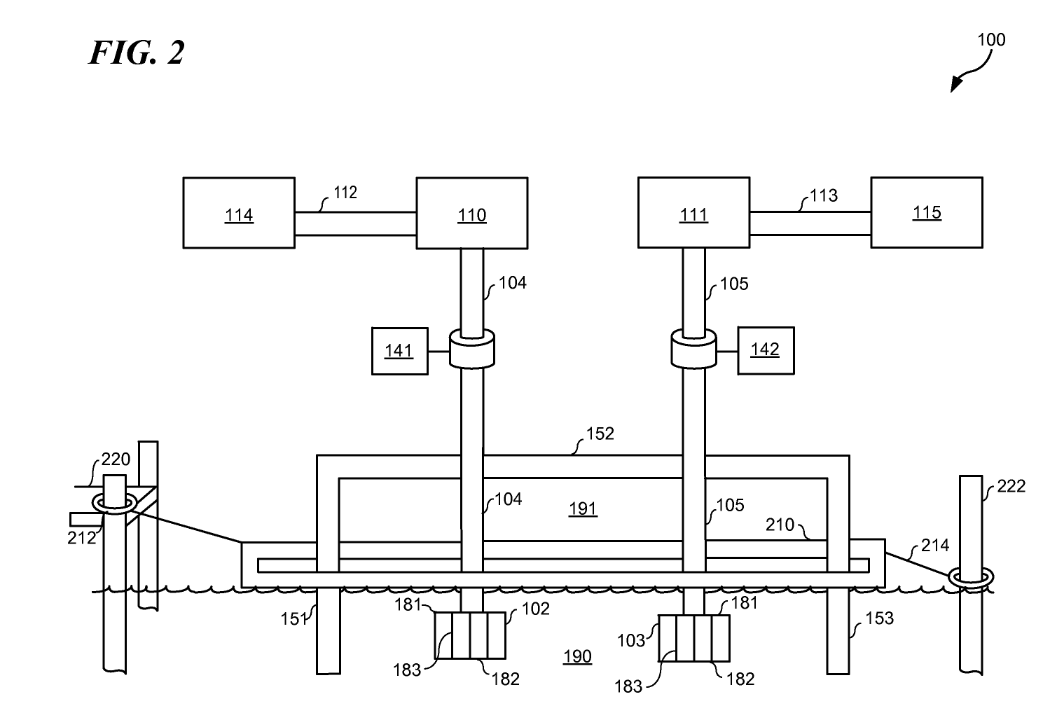

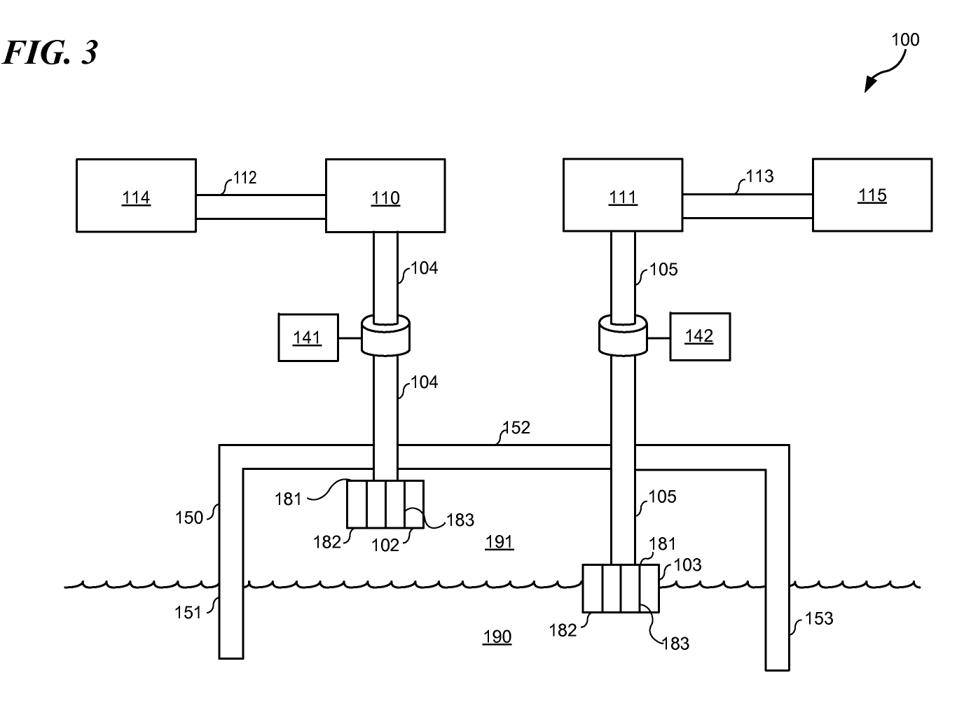

Referring now to the drawings, FIG. 1 illustrates a perspective view of an energy barge 100 embodying exemplary elements of the disclosed embodiments. In the illustrated embodiment, energy barge 100 includes a housing 300 and a barge 150. In the illustrated embodiment, housing 300 includes an enclosure providing containment of, among other things, additional elements of the disclosed embodiments as illustrated in FIGS. 2-3 and described in more detail below.

In the illustrated embodiment, barge 150 includes a left support member 151, a right support member 153, and a working platform 152. Barge 150 also includes a first axle 104, a second axle 105, a first turbine 102, and a second turbine 103, described in more detail below. In one embodiment, barge 150 floats or rests in a body of water such that the operating platform 152 rests above the waterline.

In the illustrated embodiment, barge 150 also includes lip 160. Generally, lip 160 is an extension of a bottom member disposed between left support member 151 and right support member 153. In the illustrated embodiment, lip 160 is configured as a scoop configured to direct fluid toward the turbines. One skilled in the art will understand that lip 160 can be configured in a variety of designs suitable to increase fluid flow toward the turbines.

FIG. 2 illustrates one embodiment of energy barge 100. In the illustrated embodiment, energy barge 100 includes barge 150 floating on a body of water 190. One skilled in the art will understand that barge 150 can comprise any object intended to provide a platform for operation of equipment and machinery on a body of water. For example, barge 150 can comprise transport vessels, anchored platforms, or other suitable objects. The body of water 190 can comprise any body of water having a current and a depth sufficient to at least partially fill a water channel 191, described in more detail below. Exemplary bodies of water 190 include but are not limited to lakes, oceans, rivers, and tidal zones, for example. In one embodiment, body of water 190 includes a coastal tidal area. In an alternative embodiment, body of water 190 includes a dammed lake.

In one embodiment, left support member 151 and right support member 153 are supports or floats running the length of barge 150. In one embodiment, left support member 151 and right support member 153 are pontoons upon which the energy barge 100 floats. One skilled in the art will understand that the left and right support members 151 and 152, respectively, can be any support structure for the overlying barge 150, such as anchored piers, or the like.

Generally, in one embodiment, operating surface 152 couples left support member 151 and right support member 152 along the entire length of left support member 151 and the entire length of right support member 152. Thus, in one embodiment, operating surface 152, left support member 151, and right support member 153 define the water channel 191 in which water 190 flows between left support member 151 and right support member 153. One skilled in the art will understand that a base member (not shown) can also couple left support member 151 and right support member 153 along the entire length of the members such that the base member, operating surface 152, left support member 151, and right support member 153 together form a cavity through which water can flow.

Water flow, as referred to herein, means water having a velocity in a particular direction. In the illustrated embodiments, water flow moves from a first end of barge 150 to a second end of barge 150. The first end of barge 150 is the end at which water 190 enters water channel 191, and the second end of barge 150 is the end at which water 190 leaves water channel 191. In one embodiment, barge 150 configuration creates an area of lower pressure at the second end of barge 150. So configured, a first pressure describes the atmospheric pressure of the body of water 190, and a second pressure, the area of lower pressure at the second end of barge 150, describes a pressure lower than that of the first pressure. The water 190 enters the water channel 191 and fills the water channel 191 to a depth within the body of water 190. As described above, the size and type of left support member 151 and right support member 152 determine the depth within the body of water 190.

Energy barge 100 further includes a first axle 104 and a second axle 105. First axle 104 and second axle 105 couple to barge 150 by means of a guide bearing, such that the first axle 104 and the second axle 105 pass from the interior space of the housing 300 (omitted for clarity in FIG. 2) through the operating surface 152 into the water channel 191. In addition, the coupling of the first axle 104 to barge 150, and the coupling of the second axle 105 to barge 150 allows the first axle 104 and the second axle 105 to move up and down in the plane of operating surface 152, such that the portion of the first axle 104 and the second axle 105 in the water channel 191 may vary over time. One skilled in the art will understand that disclosed embodiments contemplate and include any appropriate means to couple first axle 104 and second axle 105 to barge 150 such that the position of the first and second axles 104 and 105, respectively, can vary vertically.

Energy barge 100 also includes a first turbine 102, and a second turbine 103. In one embodiment, first turbine 102 and second turbine 103 comprise horizontal discs having an upper surface 181 and a lower surface 182. Vertical blades 183 couple to the upper surface 181 and the lower surface 182. In one embodiment, blades 183 comprise a surface area angled such that when the water flow meets an individual blade 183 the blade 183 will cause the turbine to which it is attached to rotate. Generally, blades 183 are configured to cause rotation in a clockwise or counterclockwise direction around the axle to which the turbine attaches. In one embodiment, the angle of the blades 183 of the first turbine 102 differs from the angle of the blades 183 of the second turbine 103. One skilled in the art will understand that the invention contemplates and includes all manner of devices used to transfer the kinetic energy of a moving fluid to a mechanical device. The disclosed embodiments serve to illustrate exemplary elements and not to limit the scope of the invention.

In one embodiment, first turbine 102 couples to first axle 104 such that the rotation of first turbine 102 caused by the water flow in water channel 191 causes first axle 104 to rotate. Generally, first axle 104 suspends first turbine 102 beneath the operating surface 152 in the water channel 191. Similarly, second turbine 103 couples to second axle 105 such that the rotation of second turbine 103 caused by the water flow in water channel 191 causes second axle 105 to rotate. Generally, second axle 105 suspends second turbine 103 beneath operating surface 152 in water channel 191.

As described above, first axle 104 and second axle 105 can vary their position vertically within water channel 191. The vertical variation of first axle 104 and second axle 105 allow barge 150 to variably raise and lower first turbine 102 and second turbine 103. Thus, the vertical variation of first turbine 102 and second turbine 103 dispose first turbine 102 and second turbine 103 into and out of the water 190. For example, varying the vertical position of the first axle 102 varies the vertical position of the first turbine 102. In this manner, barge 150 can lower the first turbine 102 into the water 190 and alternately raise the first turbine 102 out of the water 190.

In the illustrated embodiment, a first lift 141 couples to first axle 104, and a second lift 142 couples to second axle 105. In the illustrated embodiment, first lift 141 and second lift 142 each comprise a mechanism by which first axle 104 and second axle 105 vary their vertical position. In one embodiment, first lift 141 and second lift 142 comprise winches attached to first axle 104 and second axle 105 by means of a cable. When an individual winch applies tension to the cable, the associated axle raises vertically. When the individual winch releases tension on the cable, the associated axle lowers vertically. One skilled in the art will understand that the disclosed embodiments contemplate and include varying devices to raise and lower the first and second axles 104 and 105, respectively.

In the illustrated embodiment, first axle 104 couples to a first gearbox 110. Generally, first gearbox 110 translates the rotational energy of the first axle 104 to a first generator shaft 112. First generator shaft 112 couples to a first generator 114, providing rotational energy that first generator 114 converts to electrical energy in the form of electricity. Similarly, second axle 105 couples to a second gearbox 111. Generally, second gearbox 111 translates rotational energy of second axle 105 to a second generator shaft 113. Second generator shaft 113 couples to a second generator 115, providing rotational energy that second generator 115 converts to electrical energy in the form of electricity. Generally, generators 114 and 115 couple to and provide energy to an electrical load (not shown).

One skilled in the art will understand that the disclosed embodiments contemplate and include any mechanism that accommodates the vertical variation of the first axle 104 and the second axle 105 and translates the rotational energy of the first axle 104 and the second axle 105 to the first generator 114 and the second generator 115, respectively. In the illustrated embodiment, first axle 104 couples to a single generator 114. In an alternate embodiment, a plurality of generators 114 couple to gearbox 110. Similarly, in the illustrated embodiment, second axle 104 couples to a single generator 115. In an alternate embodiment, a plurality of generators 115 couple to gearbox 111. As used herein, rotational energy refers to the kinetic energy due to the rotation of an object, such as the rotation of the first turbine 102, the first axle 104, and the first generator shaft 112. In addition, one skilled in the art will understand that the disclosed embodiments contemplate and include any appropriate electrical generation device that uses mechanical energy to produce electrical energy, such as an electromagnetic induction generator or the like.

In the illustrated embodiment, barge 100 also includes a collar 210. Generally, collar 210 moors barge 100 to pier 220, which allowing barge 100 freedom of movement vertically as the tide raises and lowers the water depth. Generally, in one embodiment, collar 210 is configured in a generally annular shape, surrounding the outer perimeter of barge 100. Generally, collar 210 is configured to couple to a pier 220 or other stationary object. In the illustrated embodiment, collar 210 couples to pier 220 through a tie 212. Tie 212 can be configured as a rope, line, wire, rod, or other suitable mechanism to secure collar 210 to pier 220.

In the illustrated embodiment, collar 210 also couples to a pillar 222. Generally, pillar 222 is a pylori, pillar, column, or other stationary object fixed in a body of water. In the illustrated embodiment, collar 210 couples to pillar 222 though a tie 214. Tie 214 can be configured as a rope, line, wire, rod, or other suitable mechanism to secure collar 210 to pillar 222.

FIG. 3 illustrates an energy barge 100, shown with the first lift 141 having raised first axle 104, and consequently first turbine 102, out of the water 190. As illustrated, first lift 141 completely removed lower surface 182 of first turbine 102 from the water 190. Similarly, as illustrated, second lift 142 has raised second axle 105, suspending the second turbine 103 partially submerged in the water 190. As shown, second lift 142 left the lower surface 182 of second turbine 103 submerged in the water 190, thereby allowing a portion of blades 183 of second turbine 103 to contact the water 190. Thus, as described in more detail below, energy barge 100 can be configured to regulate electricity production by raising and lowering turbines into and out of the water flow.

For example, in operation in one embodiment, an entity desiring electricity places an energy barge 100 in a body of water 190. Next, the energy barge 100 receives an electrical load. The electrical load describes the total amount of electricity needed based on the use of electrically powered devices within a power grid of which the energy barge 100 includes a (generative) portion. When placed in the body of water 190, energy barge 100 receives water at the first end of barge 150. That is, water 190 enters water channel 191 at the first end of barge 150 and flows through water channel 191 to the second end of barge 150.

In response to (or in advance of) the electrical load, energy barge 100 lowers first turbine 102 partially into the body of water 190 such that the water flow through water channel 191 rotates first turbine 102 about an axis of first axle 104, thereby driving generator 114 to produce electricity to meet the electrical load. In the event that the electrical load is greater than the electricity produced by first generator 114, first lift 141 lowers first turbine 102 into water channel 191 until first turbine 102 is completely submerged in the water 190.

In the event that the electrical load is greater than the electricity produced by the completely submerged first turbine 102, second lift 142 lowers second turbine 103 partially into water 190 such that the water flow through water channel 191 rotates second turbine 103 about an axis of second axle 105, thereby driving second generator 115 to produce electricity to meet the electrical load. As used herein, the term “driving a generator” refers to causing sufficient rotation in a turbine such that the turbine rotation causes electrical production through the above-described mechanisms. As used herein, to “produce electricity” refers to the operation of a generator in such a manner that a net electrical output results from the mechanical operation of the generator.

In the event that the water flow through water channel 191 does not cause first turbine 102 or second turbine 103 to rotate when completely submerged, the entity needing electricity can reposition the energy barge 100 to a location having a more suitable water flow. For example, the entity needing electricity can move the energy barge 100 in the body of water 190 such that the water flow rotates at least the first turbine 102. Repositioning can include moving barge 150 such that the first end of barge 150 faces a new direction, for example. In addition, repositioning can also include moving energy barge 100 to another body of water 190 where sufficient water flow exists to rotate first turbine 102 and second turbine 103.

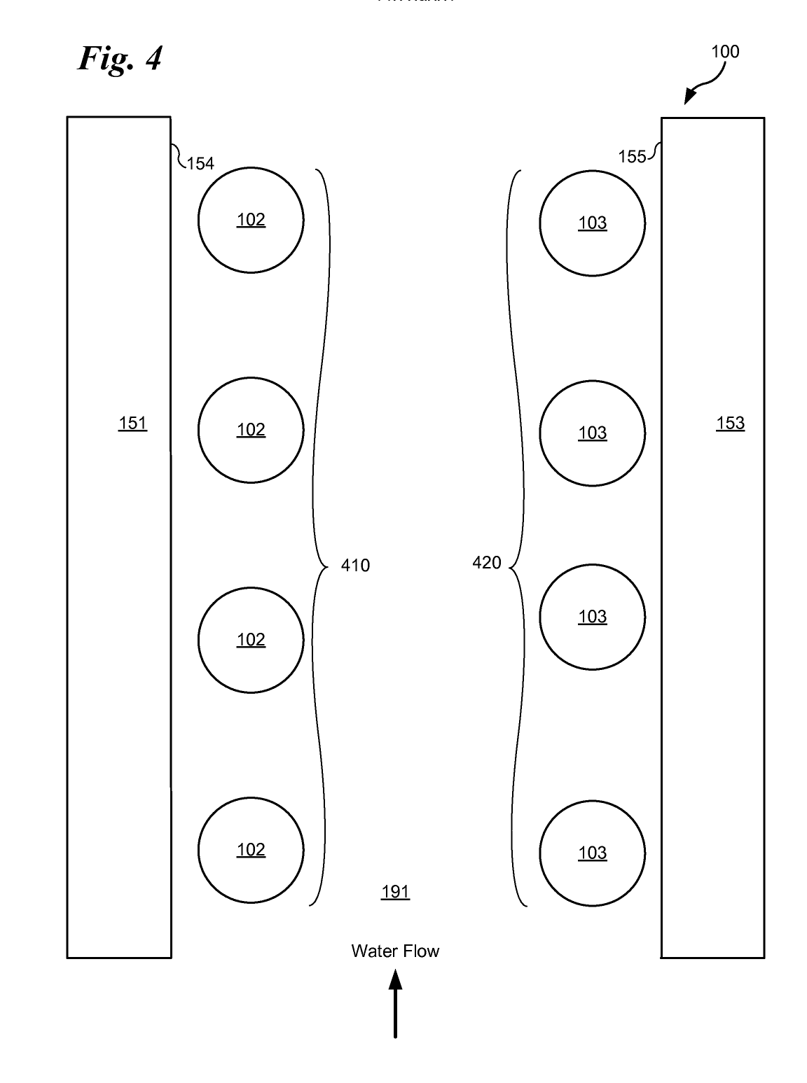

FIGS. 4-9 illustrate overhead views of exemplary configurations of energy barge 100, just below the operating surface 152. All exemplary energy barges 100 illustrated in FIGS. 4-9 operate as described above with respect to FIGS. 2 and 3 with modifications as described below. Furthermore, in FIGS. 4-9, energy barge 100 includes a left-series turbine module 410, and a right-series turbine module 420. The left-series turbine module 410 includes a plurality of first turbines 102 coupled to the energy barge by axles as described above. As illustrated, the left-series turbine module 410 includes those turbines closer to left support member 151 than right support member 152. The right-series turbine module 420 includes a plurality of second turbines 103 coupled to the energy barge by axles as described above. As illustrated, the right-series turbine module 420 further includes those turbines closer to right support member 153 than left support member 151. The portion of the left support member 151 facing the water channel 191 includes a first vertical wall 154. Similarly, the portion of the right support member 152 facing the water channel 191 includes a second vertical wall 155. As used herein, a turbine module, such as the left-series turbine module 410, arranged in series describes a turbine arrangement that aligns the turbines parallel to a vertical wall, such as the first vertical wall 154. For example, as illustrated in FIG. 4, the left-series turbine module 410 aligns the turbines such that a vertical plane passing through an axis of each turbine is generally parallel to the first vertical wall 154.

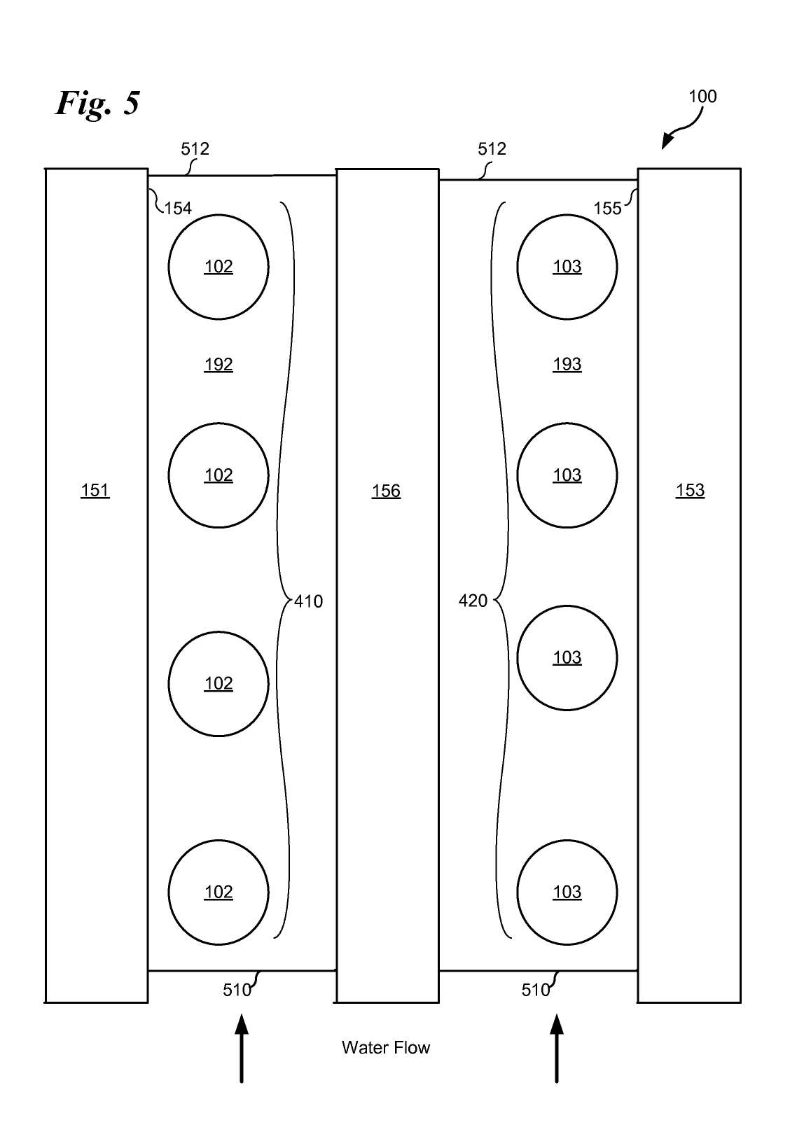

FIG. 5 illustrates an alternate embodiment of energy barge 100, wherein the energy barge 100 further includes a center support member 156. In the illustrated embodiment, the center support member 156 divides water channel 191 into a first water channel 192 and a second water channel 193. As illustrated, energy barge 100 suspends the left-series turbine module 410 in first water channel 192, and suspends the right-series turbine module 420 in second water channel 193.

In one embodiment, barge 100 includes one or more trash guards 510. In one embodiment, trash guards 510 comprise a mesh screen disposed between support member 151 and support member 156, and between support member 156 and support member 153. Generally, trash guards 510 protect the downstream turbines by reducing debris in the water 190 by preventing the debris from reaching the blades 183. In one embodiment, trash guards 510 do not hinder the interaction of the water flow in the channels 192 and 193 with the first turbine 102 or the second turbine 103. One skilled in the art will understand that the embodiments disclosed herein contemplate and include all manner of devices used to prevent debris, such as trash and silt, from hindering the interaction of the turbine and the water.

In one embodiment, barge 100 includes one or more fish guards 512. In one embodiment, trash guards 512 comprise a mesh screen disposed between support member 151 and support member 156, and between support member 156 and support member 153. In the illustrated embodiment, fish guards 512 are installed at or near the downstream end of water channels 192 and 193. Generally, fish guards 512 discourage fish and other wildlife from entering the downstream end of water channels 192 and 193. In one embodiment, fish guards 512 are configured as a sieve with openings sufficient for water to pass through, but configured to block wildlife above a certain size. In one embodiment, fish guards 512 are configured to block and/or discourage wildlife common to the local environment wherein barge 100 operates from entering channels 192 and/or 193. In an alternate embodiment, fish guards 512 are configured to discourage wildlife-in-general from entering channels 192 and/or 193. One skilled in the art will understand that the embodiments disclosed herein contemplate and include all manner of devices used to prevent and/or discourage wildlife from entering into an area and can be expressly configured to focus on one or more species in particular.

In the illustrated embodiment, barge 100 includes trash guards 510 at the upstream side of barge 100 and fish guards 512 at the downstream side of barge 100. In an alternate embodiment, barge 100 includes trash guards 510 at the downstream side of barge 100 and fish guards 512 at the upstream side of barge 100. In an alternate embodiment, barge 100 includes fish guards 512 at both the upstream and downstream sides of barge 100. In an alternate embodiment, barge 100 includes trash guards 510 at both the upstream and downstream sides of barge 100. One skilled in the art will understand that other configurations can also be employed.

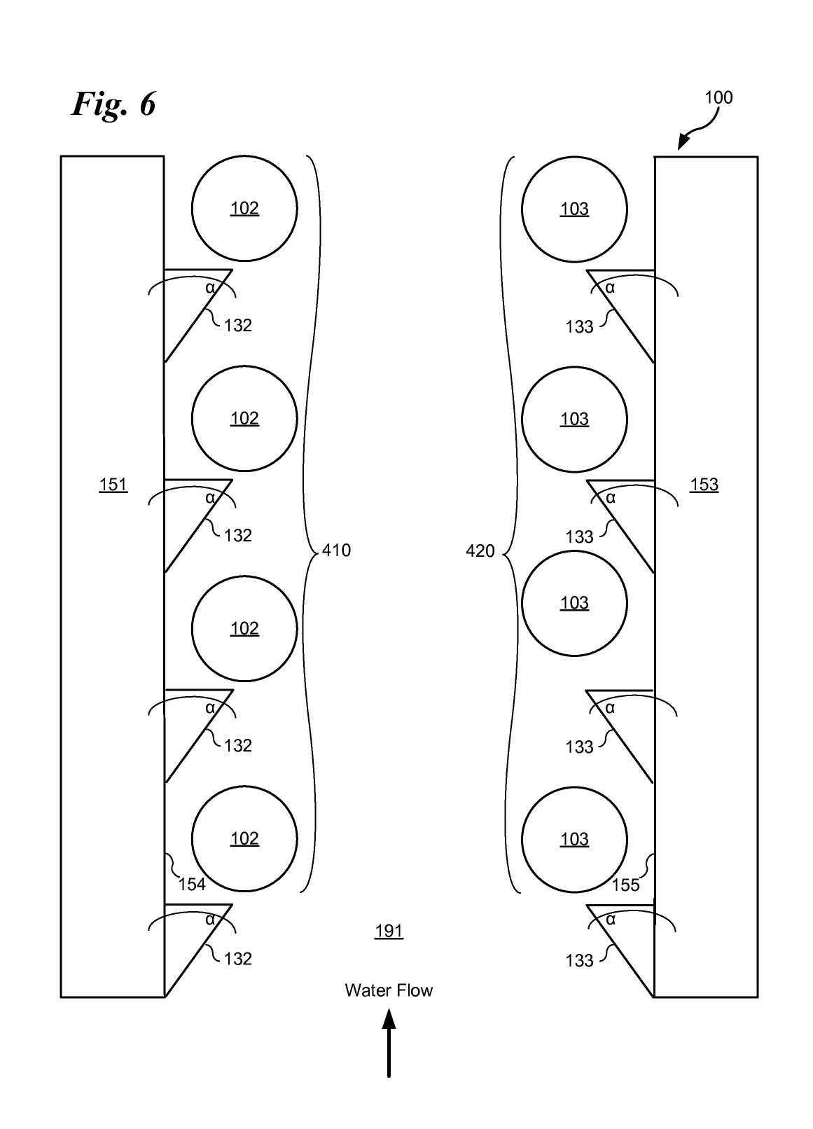

FIG. 6 illustrates an alternative configuration of energy barge 100 wherein left support member 151 further includes a first series of baffles 132. In one embodiment, each baffle 132 includes an angle α of about 60°. Similarly, in one embodiment, right support member 153 further includes a second series of baffles 133. In one embodiment, each baffle 133 includes an angle α of about 60°. Generally, baffles 132 and 133 comprise objects affixed to the support members to block water flow in the water channel 191 on a side of the turbines moving into the water flow, and to direct the water flow toward a side of the turbines moving with the water flow. One skilled in the art will understand that, with respect to wind turbines, these sides would be termed “upwind” or “drag” and “downwind” or “power” sides. In one embodiment, the “power” side is the half of the turbine that is rotating with the fluid and the “drag” side is the half of the turbine that is rotating against the fluid. In one embodiment, the “upwind” side is the half of the turbine oriented toward the fluid flow and the “downwind” side is the half of the turbine oriented away from the fluid flow.

In one embodiment, baffles 132 and 133 comprise flat panels. In an alternate embodiment, baffles 132 and 133 comprise solid protrusions. One skilled in the art will understand that the disclosed embodiments contemplate and include any appropriate object attached to support members 152 and 153 such that the object directs water flow away from the “upwind” side of an associated turbine. Furthermore, the disclosed embodiments contemplate baffles suspended from operating surface 152 or attached to energy barge 100 in a manner allowing the baffle to direct water flow away from the “upwind” side of an associated turbine.

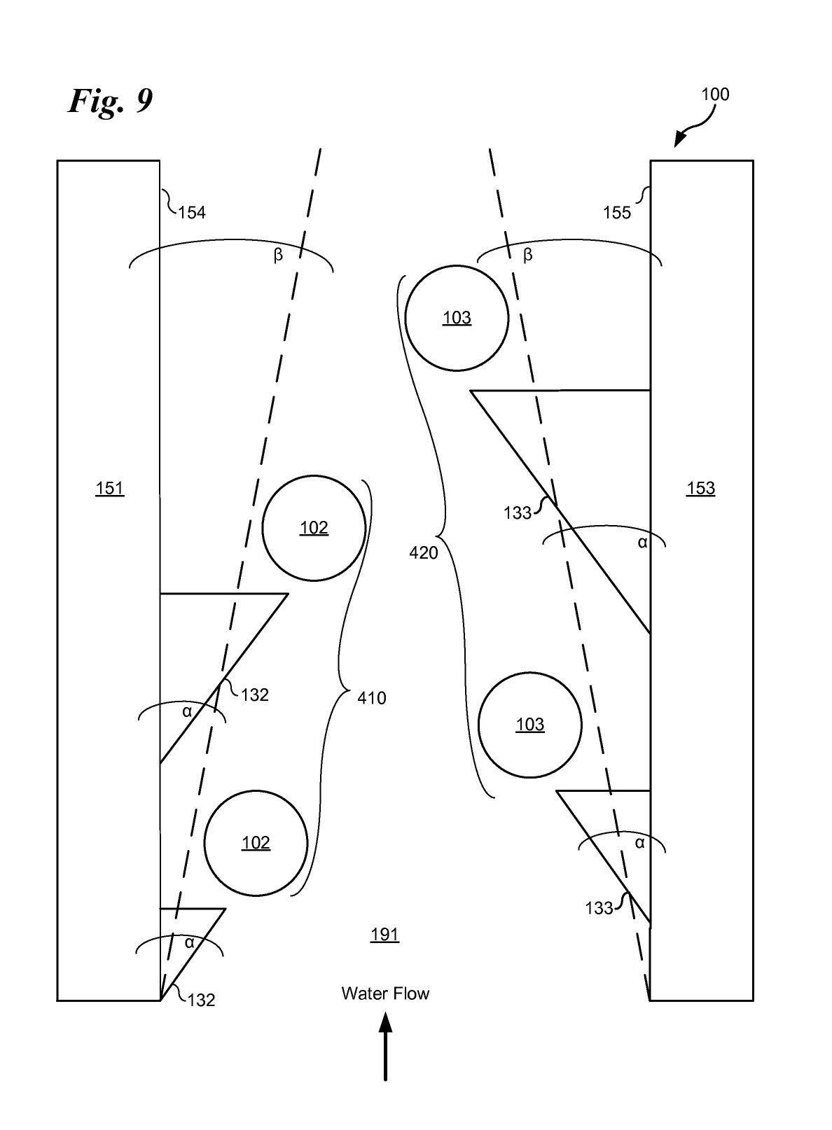

In addition, the individual baffles 132 and 133 can vary in size as necessary to direct water flow away from the “upwind” side of an associated turbine such as shown in FIG. 9, below, for example. In one embodiment, the angle α describes the angle of the directional change in the water flow caused by the first series baffles 132 and the second series baffles 133 and can vary according to the particular energy barge 100 and body of water 190 in which placement of the energy barge 100 occurs. In one embodiment, baffles 132 and 133 are configured to vary angle α in response to varying water flow conditions locally at a particular turbine, and/or generally within water channel 191.

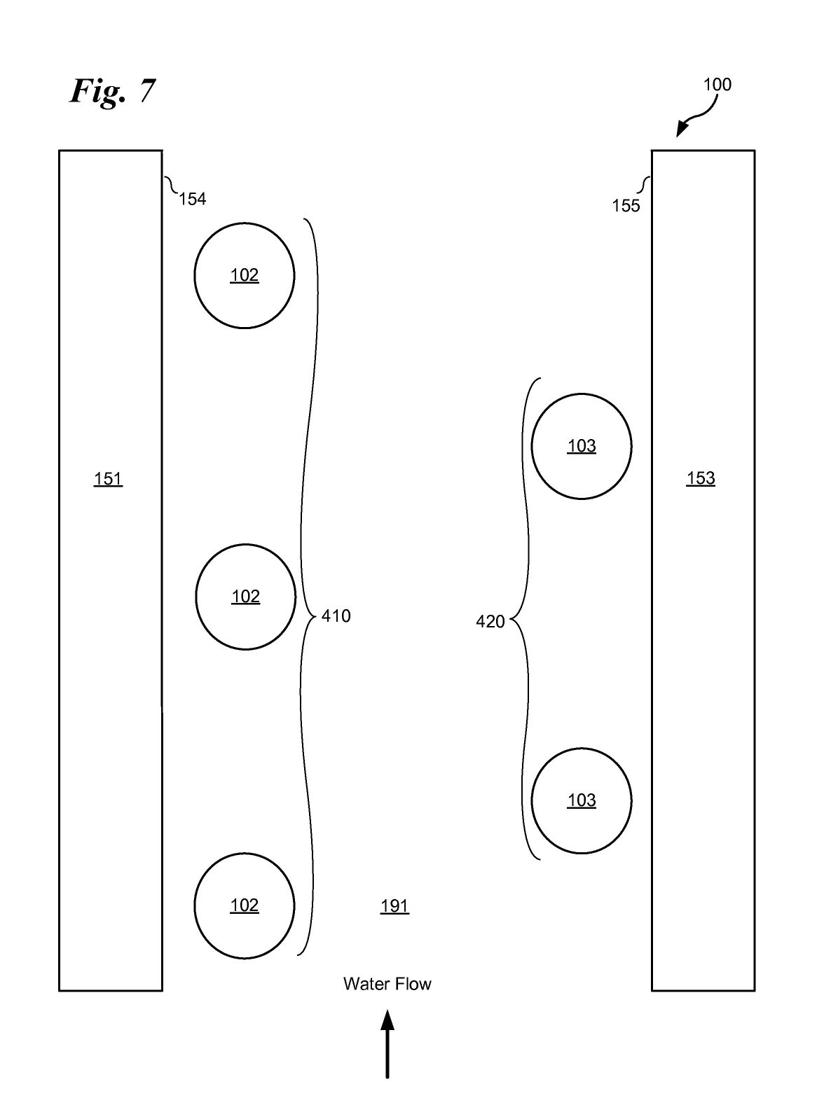

FIG. 7 illustrates an alternate configuration of energy barge 100 wherein the left-series turbine module 410 and the right-series turbine module 420 comprise staggered turbines. In one embodiment, “staggered” refers to placement of the left-series turbine module 410 and the right-series turbine module 420 such that a vertical plane perpendicular to the first vertical wall 154 or the second vertical wall 155 drawn through an axis of a first turbine 102 or a second turbine 103 does not pass through the axis of a turbine of the opposite turbine module. In one embodiment, “parallel” turbines refers to alignment of a first turbine 102 in the left-series turbine module 410 with a second turbine 103 in the right-series turbine module 103 such that a vertical plane perpendicular to the first vertical wall 154 or the second vertical wall 155 drawn through an axis of the first turbine 102 will pass through the axis of the second turbine 103 and vice versa.

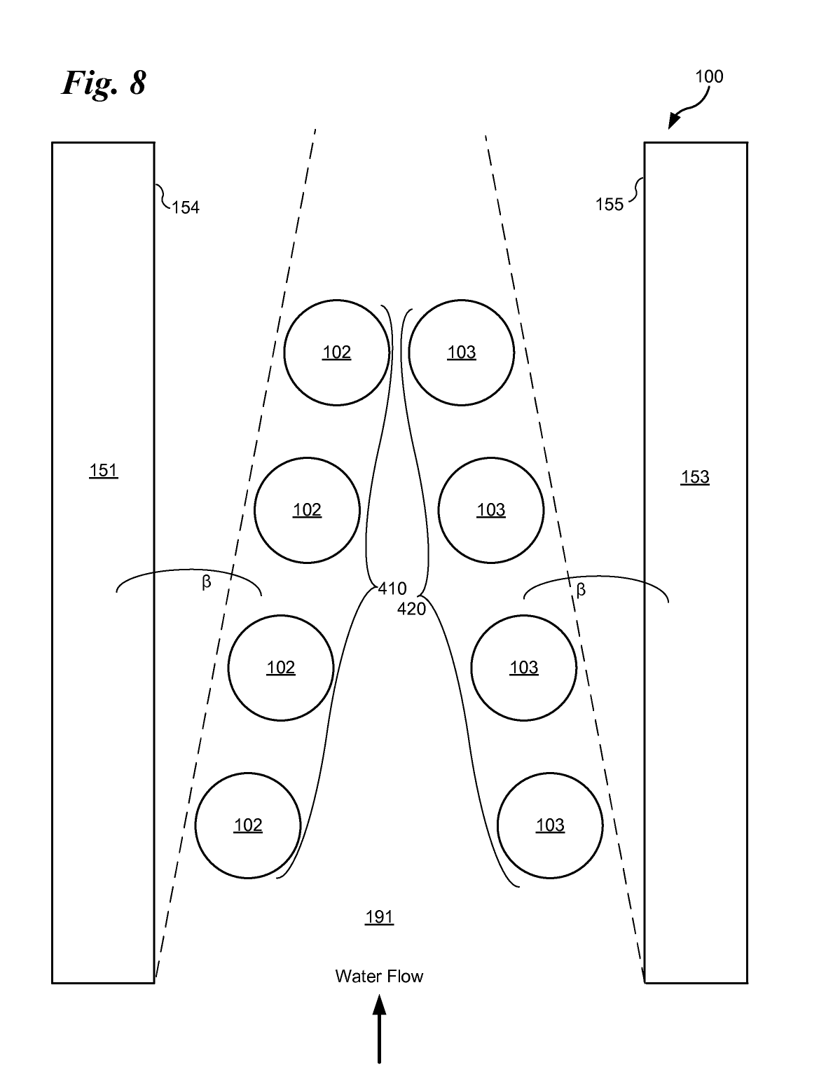

FIG. 8 illustrates an alternative configuration of energy barge 100 wherein placement of an outer edge of the left-series turbine module 410 coincides with a vertical plane intersecting the first vertical wall 154 at an angle β. Similarly, placement of an outer edge of the right-series turbine module 420 coincides with a vertical plane intersecting the second vertical wall 155 at an angle β′. The angles β and β′ refer to the alignment angle at which each successive turbine in a respective turbine module is disposed with respect to the next turbine closest to the first end of barge 150. One skilled in the art will understand that the disclosed embodiments contemplate and include wide variation in angle β and β′ as befits the particular energy barge 100 and the body of water 190 in which placement of the respective energy barge 100 occurs. As such, energy barge 100 can be configured to optimize the extraction of energy from water flow in water channel 191.

FIG. 9 illustrates an alternative configuration of energy barge 100 comprising various elements of FIGS. 4-8. As illustrated, placement of an outer edge of the left-series turbine module 410 coincides with a vertical plane intersecting the first vertical wall 154 at angle β. Similarly, placement of an outer edge of the right-series turbine module 420 coincides with a vertical plane intersecting the second vertical wall 155 at angle β. In addition, in the illustrated embodiment, the left-series turbine module 410 and the right-series turbine module 420 are staggered. In the illustrated embodiment, left support member 151 further includes a first series of baffles 132 having an angle α of about 60°. Similarly, the right support member 153 further includes a second series of baffles 133 having an angle α of about 60°. As described above, in the illustrated embodiment the individual baffles in the first series of baffles 132 and the second series of baffles 133 vary in size to better direct water flow away from the “upwind” side of an associated turbine. Thus, one skilled in the art will understand that one or more of these features can be employed based on the expected water flow through water channel 191 at the expected barge operating environment.

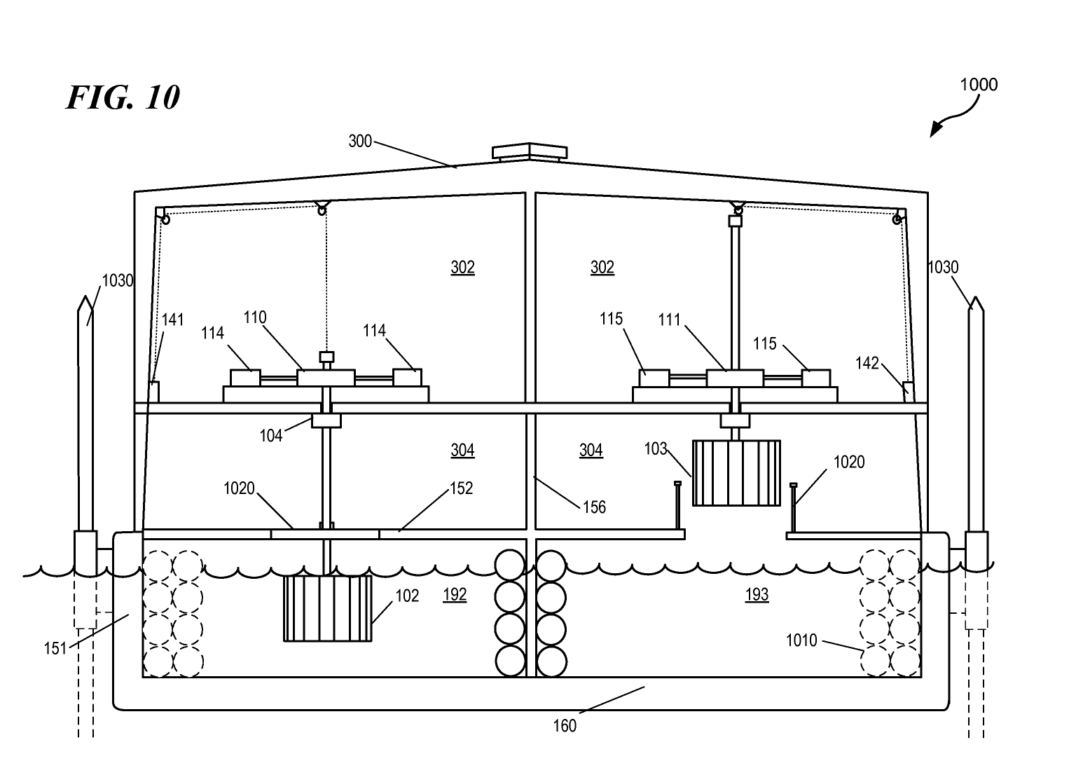

FIG. 10 illustrates an exemplary energy barge 1000 in accordance with one embodiment. In the illustrated embodiment, barge 1000 includes housing 300. As shown, housing 300 includes an upper chamber 302 and a middle chamber 304. In the illustrated embodiment, upper chamber 302 encloses the gearboxes 110 and generators 114 coupled to turbine 102 and the gearboxes 111 and generators 115 coupled to turbine 103.

In the illustrated embodiment, middle chamber 304 encloses turbines 102 and 103 when in the raised position. In the illustrated embodiment, middle chamber 304 includes a trap door 1020 configured to allow a turbine to pass through working platform 152 into (or out of) channel 192 and 193.

In the illustrated embodiment, barge 1000 includes a plurality of floats 1010. Generally, floats 1010 are configured to provide buoyancy to barge 1000 and can be configured to assist in maintaining a stable water depth in channels 192 and 193. One skilled in the art will understand that floats 1010 can be any suitable floatation device suitable for employment in water channels 192 and 193.

In the illustrated embodiment, barge 1000 also includes a plurality of guide pylons 1030. Generally, in one embodiment, guide pylons 1030 are configured to assist in maneuvering and mooring barge 1000. As such, pylons 1030 can be configured as any suitable maneuvering, navigational, and/or mooring aid.

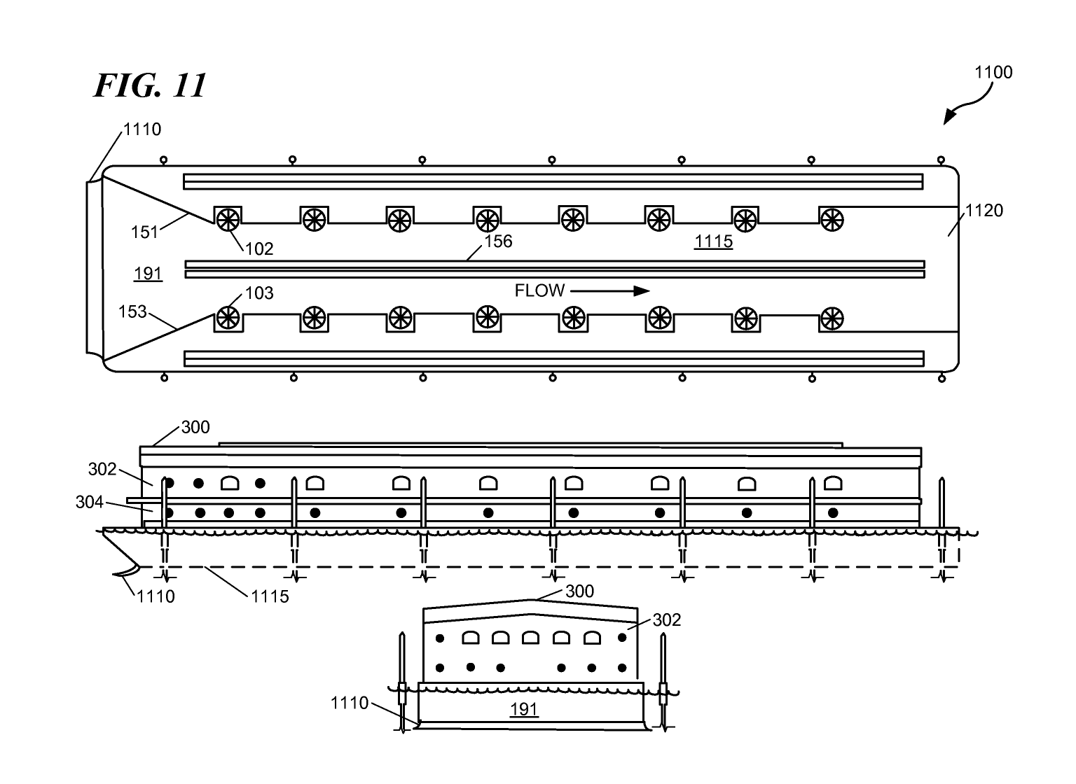

FIG. 11 illustrates, in a variety of perspectives, an exemplary energy barge 1100 in accordance with one embodiment. In the illustrated embodiment, barge 1100 includes a channel bottom 1115. Generally, in one embodiment, channel bottom 1115 defines a lower wall configured to retain water flow within a predetermined distance from the bottom of the turbines when fully deployed. Bottom 1115 can also be configured as an otherwise conventional hull, or other suitable structure. In one embodiment, bottom 1115 is further configured to block and/or discourage wildlife from entering water channel 191.

In the illustrated embodiment, barge 1100 includes a forward lip 1110 and a rear lip 1120. Generally, forward lip 1110 is an extension of a bottom member disposed between left support member 151 and right support member 153. In the illustrated embodiment, lip 1110 is configured as a scoop configured to direct fluid toward the turbines. In one embodiment, lip 1110 extends between 1 to 3 feet below bottom 1115. One skilled in the art will understand that lip 1110 can be configured in a variety of designs suitable to increase fluid flow toward the turbines.

Generally, rear lip 1120 is an extension of a bottom member disposed between left support member 151 and right support member 153 at the rear of channel 191. In the illustrated embodiment, lip 1120 is configured as a flat ledge configured to direct fluid away from the end of barge 1100. One skilled in the art will understand that lip 1120 can be configured in a variety of designs suitable to increase fluid flow toward the turbines.

In the illustrated embodiment, barge 1100 includes a v-shaped opening at the forward end of water channel 191. Specifically, the forward support members, such as left support member 151, for example, form an angled entrance conduit leading into a narrower segment of channel 191. So configured, barge 1100 can operate with turbines closer to a midline, which allows flexibility in turbine placement. One skilled in the art will understand that channel 191 can be configured without a v-shaped opening, a narrower or wider opening than the illustrated opening, or otherwise suitable configured.

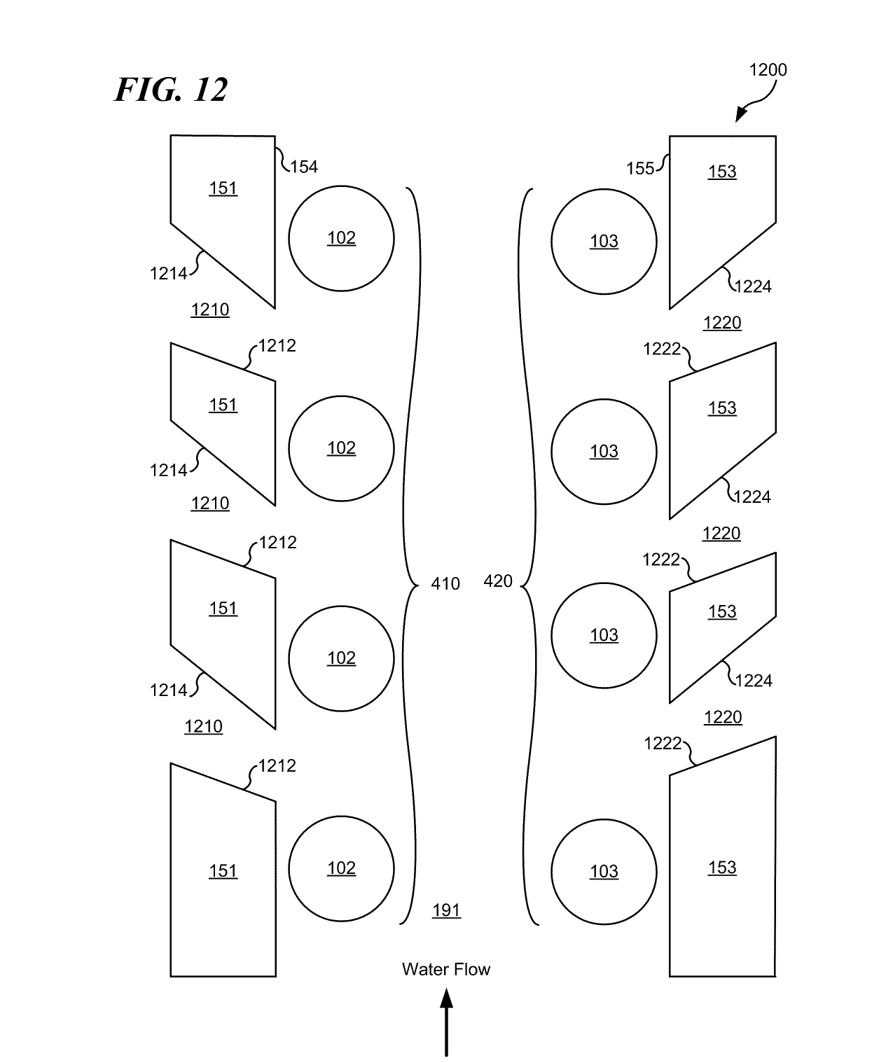

FIG. 12 illustrates a barge 1200 in accordance with another embodiment. In the illustrated embodiment, left support member 151 is configured in segments, the segments defining a plurality of vents 1210. In the illustrated embodiment, a vent 1210 is generally configured to allow water from channel 191 to pass through support member 151 into the body of water in which barge 1200 is disposed.

Generally, support member 151 includes a plurality of forward faces 1212 and a plurality of rear faces 1214. In the illustrated embodiment, each forward face 1212 is disposed near the downstream side of a turbine 102. Similarly, in the illustrated embodiment, each rear face 1214 is disposed near the upstream side of a turbine 102. In the illustrated embodiment, the angle formed between the forward face 1212 and the channel 191 is a different angle than the angle formed between the rear face 1214 and the channel 191. In one embodiment, the forward face 1212 and the rear face 1214 are configured to minimize drag on the drag side of a nearby turbine 102.

In the illustrated embodiment, left support member 153 is configured in segments, the segments defining a plurality of vents 1220. In the illustrated embodiment, a vent 1220 is generally configured to allow water from channel 191 to pass through support member 153 into the body of water in which barge 1200 is disposed.

Generally, support member 153 includes a plurality of forward faces 1222 and a plurality of rear faces 1224. In the illustrated embodiment, each forward face 1222 is disposed near the downstream side of a turbine 103. Similarly, in the illustrated embodiment, each rear face 1224 is disposed near the upstream side of a turbine 103. In the illustrated embodiment, the angle formed between the forward face 1222 and the channel 191 is a different angle than the angle formed between the rear face 1224 and the channel 191. In one embodiment, the forward face 1222 and the rear face 1224 are configured to minimize drag on the drag side of a nearby turbine 103.

In the illustrated embodiment, barge 1200 includes two vent types, vent 1210 and vent 1220. In one embodiment, vent 1210 is configured as an outboard vent, disposed on the side of barge 1200 opposite that of the shoreline of the body of water in which barge 1200 is disposed. In one embodiment, vent 1220 is configured as an inboard vent, disposed on the side of barge 1200 next to the shoreline of the body of water in which barge 1200 is disposed. So configured, vent 1210 and vent 1220 can be configured to take into account varying current patterns between barge 1200 and the shoreline, and between barge 1200 and the rest of the body of water in which barge 1200 is disposed.

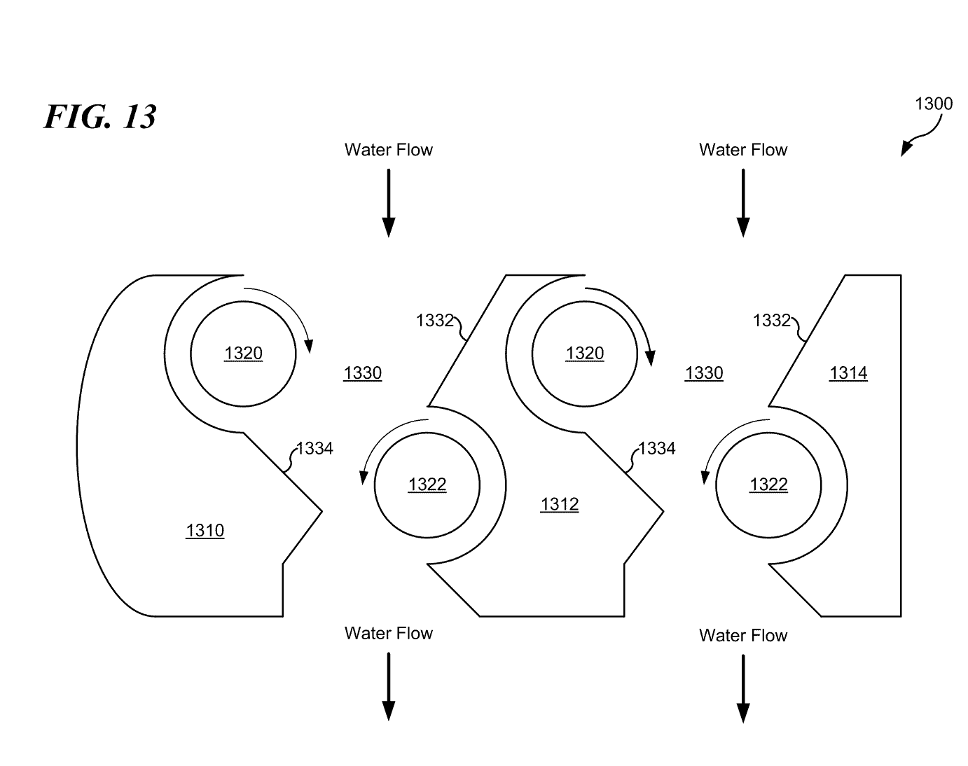

FIG. 13 illustrates a barge 1300 in accordance with another embodiment. Generally, in the illustrated embodiment, barge 1300 is configured to receive fluid flow along a side, in contrast with barge 1200, for example, which receives fluid flow from its bow (or stern). In the illustrated embodiment, barge 1300 includes a bow member 1310 and a stern member 1314, offered as abstractions so as not to obscure features of the disclosed embodiment.

Generally bow member 1310 is an abstraction of those components of an energy barge as described herein that are not otherwise described with respect to FIG. 13, and that are generally forward or above of turbines 1320 and 1322. Generally stern member 1314 is an abstraction of those components of an energy barge as described herein that are not otherwise described with respect to FIG. 13, and are generally aft or above turbines 1320 and 1322.

Barge 1300 also includes midship member 1312. Generally, midship member 1312 is an abstraction of those components of an energy barge as described herein that are not otherwise described with respect to FIG. 13, and are not otherwise abstracted into bow member 1310 or stern member 1314. In the illustrated embodiment, midship member 1312 is offered as an abstraction so as not to obscure features of the disclosed embodiment.

In the illustrated embodiment, barge 1300 includes a plurality of turbines, turbines 1320 and turbines 1322. Generally, turbine 1320 and turbine 1322 are vertical turbines as described herein. In the illustrated embodiment, turbines 1320 and 1322 are disposed within a water channel 1330. As illustrated, water flow enters and exits channel 1330 from a side position of barge 1300.

Generally, structural members 1332 and 1334 define a water channel 1330. In the illustrated embodiment, structural members 1332 and 1334 are configured such that turbine 1320 rotates clockwise and turbine 1322 rotates counter-clockwise. Additionally, in the illustrated embodiment, member 1332 is further configured to direct fluid toward the power side of turbine 1322 and away from the drag side of turbine 1322. Similarly, in the illustrated embodiment, member 1334 is further configured to direct fluid toward the power side of turbine 1322 and away from the drag side of turbine 1320.

In the illustrated embodiment, barge 1300 is shown with two rows of turbines, one row of turbines 1320 and one row of turbines 1322, disposed offset from turbines 1320. In an alternate embodiment, a plurality of turbines 1322 are disposed such that each turbine is equidistant from each of its nearest upstream turbines 1320. Barge 1300 can also be configured in alternate embodiments including wide variation in the number and arrangement of turbines 1320 and 1322.

Additionally, in the illustrated embodiment, barge 1300 is shown with member 1322 and 1334 directing fluid within channel 1330. In an alternate embodiment, channel 1330 can be configured in a similar manner as channel 191, as described above. In an alternate embodiment, one or more member 1332 or 1334 can be omitted. Generally, barge 1300 can also be configured in alternate embodiments including wide variation in the design, arrangement, and flow-direction characteristics of members 1332 and 1334. As such, barge 1300 is shown as an exemplary embodiment of an energy barge as described above, configured for side-to-side water flow.

Thus, the disclosed embodiments provide numerous advantages over prior art systems for generating electricity. In addition to the inherent advantages of hydroelectric power generation over nuclear power generation, fossil fuel power generation, and wind power generation, the disclosed embodiments do not require construction of a dam. Because the disclosed embodiments may operate in any body of water having some current flow, the capital required to build and operate the disclosed embodiments is significantly less than that of prior art methods of hydroelectric power generation. Eliminating the need for a dam also avoids the property devaluation associated with prior arts methods and systems of hydroelectric power generation.

Furthermore, the geographic limitations for use of the disclosed embodiments are significantly less restricted than prior art methods and systems of hydroelectric power generation. Placement of the disclosed embodiments can occur in any body of water having water flow. In the event that the water flow in the body of water ceases, the disclosed embodiments can be moved to another location where electricity production can continue. This allows entities using the disclosed embodiments to produce electricity at a cheaper rate and with flexibility to accommodate wide variation within the operating environment. In addition, the ability to engage a wide variety of turbines allows the disclosed embodiments to finely tune electricity production to the electrical load reducing wasted efforts associated with prior art methods of hydroelectric electricity production.

The disclosed embodiments provide further advantage by preventing any device within the system carrying electricity from contacting the water. As such, the risk of safety problems occurring on the energy barge 100 is somewhat reduced. In addition, the support members of the barge decrease drag on the turbines by blocking the movement of water on the non-power side. Finally, the disclosed embodiments allow the first turbine 102 and the second turbine 103 to switch positions as needed, which extends the operational life of the turbines, further reducing costs.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A power generating system, comprising:
a barge comprising a working platform, a left water support member, and a right water support member, the barge configured to provide an operating surface on a body of water;
wherein the left water support member and the right water support member define a first water channel;
the first water channel comprising a portion of the body of water to a depth within the body of water;
wherein a water flow from the body of water flows directionally through the first water channel;
a first axle coupled to the barge;
a first turbine coupled to the first axle and comprising a plurality of blades, the first turbine configured to rotate on an axis of the first axle in the first water channel according to the water flow;
a first gearbox configured to transmit rotational energy of the first axle to a first generator, the rotational energy operating the first generator to produce electricity; and
a first lift coupled to the first axle, the first lift configured to raise and lower the first turbine.

2. The system of claim 1, further comprising a trash guard surrounding the first turbine.

3. The system of claim 1, wherein the barge further comprises:
a first end configured to receive water from the body of water at a first pressure;
a second end configured to receive water from the body of water at a second pressure;
wherein the second pressure is less than the first pressure.

4. The system of claim 1, further comprising a first baffle positioned within the first water channel, the first baffle configured to direct the water flow toward the first turbine.

5. The system of claim 4, wherein the first baffle affixes to the left water support member at an angle α.

6. The system of claim 4, wherein the first baffle affixes to the right water support member at an angle α.

7. The system of claim 1, further comprising:
the first water support member comprising a first vertical wall;
the second water support member comprising a second vertical wall;
a second axle coupled to the barge;
a second turbine coupled to the second axle and comprising blades, the second turbine configured to rotate on an axis of the second axle in the first water channel according to the water flow;
a second gearbox configured to transmit rotational energy of the second axle to a second generator, the rotational energy operating the second generator to produce electricity; and
a second lift coupled to the second axle, the second lift configured to variably raise and lower the second turbine.

8. The system of claim 7, further comprising the first turbine and the second turbine suspended in the first water channel in series such that a plane parallel to the first vertical wall passes through the axis of the first axle and the axis of the second axle.

9. The system of claim 7, further comprising the first turbine and the second turbine suspended in the first water channel in series such that a plane passing through the axis of the first axle and the axis of the second axle intersects the first vertical wall at an angle β.

10. The system of claim 1, wherein the first water channel is configured to guide water flow from one side of the barge to another side of the barge.

11. The system of claim 1, wherein the first water support member comprises a vent configured to allow fluid to exit the first water channel without travelling the entire length of the first water channel.

12. The system of claim 7, further comprising the first turbine and the second turbine suspended in the first water channel in parallel such that a plane perpendicular to the first vertical wall passes through the axis of the first axle and the axis of the second axle.

13. The system of claim 1, further comprising:
a third water support member, the third water support member configured to define a second water channel;
a second axle, the second axle coupled to the barge;
a second turbine coupled to the second axle and comprising blades, the second turbine configured to rotate on an axis of the second axle in the second water channel according to the water flow;
a second gearbox configured to transmit rotational energy of the second axle to a second generator, the rotational energy operating the second generator to produce electricity; and
a second lift coupled to the second axle, the second lift configured to variably raise and lower the second turbine.

14. A power generating system, comprising:
a barge comprising a working platform, a left water support member, and a right water support member, the barge configured to provide an operating surface on a body of water;
the first water support member comprising a first vertical wall;
the second water support member comprising a second vertical wall;
wherein the left water support member and the right water support member define a first water channel;
the first water channel comprising a portion of the body of water to a depth within the body of water;
wherein a water flow from the body of water directionally flows through the first water channel;
a left-series comprising four axles in series, a right-series comprising four axles in series, wherein each axle in the left-series and the right-series couple to the barge;
a turbine left-series comprising four turbines in series, wherein each left-series turbine coupled to a respective left-series axle;
a turbine right-series comprising four turbines in series, wherein each right-series turbine couples to a respective right-series axle;
wherein each left-series turbine and each right-series turbine is further configured to rotate on an axis about the associated left-series axle or right-series axle, respectively;
a plurality of gearboxes configured to transmit rotational energy of each of the left-series and right-series axles to a plurality of generators, wherein the generators are configured to transform received rotational energy to produce electricity; and
a plurality of lifts, wherein each lift couples to one of the left-series or right-series axles, each lift configured to variably raise and lower the associated left-series turbine and each right-series turbine into and out of the first water channel.

15. The system of claim 14, further comprising:
the left-series turbines and the right-series turbines suspended in the first water channel in parallel such that a plane perpendicular to the first vertical wall passes through the axis of a left-series axle and the axis of a right-series axle;
the left-series turbines suspended in the first water channel in series such that a plane parallel to first vertical wall passes through the axes of the left-series axles; and
the right-series turbines suspended in the first water channel in series such that a plane parallel to left vertical wall passes through the axes of the right-series axles.

16. The system of claim 14, further comprising:
the left-series turbines and the right-series turbines suspended in the first water channel in parallel such that a plane perpendicular to the first vertical wall passes through the axis of a left-series axle and the axis of a right-series axle;
the left-series turbines suspended in the first water channel in series such that a plane passing through the axis of each left-series axle intersects the first vertical wall at an angle β; and
the right-series turbines suspended in the first water channel in series such that a plane passing through the axis of each right-series axle intersects the second vertical wall at an angle β.

17. A method for generating electricity, comprising:
disposing an energy barge in a body of water, the energy barge comprising a first turbine;
receiving an electrical load;
lowering the first turbine into the body of water such that a water flow in the body of water rotates the first turbine to drive a generator to produce electricity to meet the electrical load; and
wherein the first turbine is oriented vertically with respect to a surface of the body of water.

18. The method of claim 17, further comprising: in the event that the electrical load is greater than the electricity produced by the first turbine, further lowering the first turbine into the body of water.

19. The method of claim 18, further comprising:
wherein the energy barge comprises a second turbine; and
in the event that the electrical load is greater than the electricity produced by the first turbine, lowering the second turbine into the body of water until the water flow of the body of water rotates the second turbine to drive an second generator to produce electricity.

20. The method of claim 18, further comprising:
in the event that the water does not rotate the first turbine, repositioning the energy barge in the body of water such that the water imparts rotation to the first turbine; and
in the event that repositioning the energy barge in the body of water does not rotate the first turbine, disposing the energy barge into another body of water.
